(19) United States
(12) Patent Application Publication
(10) Pub. No.: US 2014/0070610 A1
(43) Pub. Date: Mar. 13, 2014

(54) CENTRALIZED MANAGEMENT OF THE SUPPLY OF POWER TO A PLURALITY OF LOCAL POWER NETWORKS

(71) Applicants: Laurent Massoulie, Vaucresson (FR); Srinivasan Keshav, Waterloo (CA); Nidhi Hegde, Les Moulineaux Cedex (FR); Theodoros Salonidis, New York, NY (US)

(72) Inventors: Laurent Massoulie, Vaucresson (FR); Srinivasan Keshav, Waterloo (CA); Nidhi Hegde, Les Moulineaux Cedex (FR); Theodoros Salonidis, New York, NY (US)

(73) Assignee: THOMSON LICENSING, Issy de Moulineaux (FR)

(21) Appl. No.: 14/005,547

(22) PCT Filed: Mar. 16, 2012
(86) PCT No.: PCT/EP2012/054722

§ 371 Date: Nov. 22, 2013

(30) Foreign Application Priority Data
Mar. 18, 2011 (EP) 11305310.2
Apr. 8, 2011 (EP) 11305417.5

(51) Int. Cl. H02J 9/00

(52) U.S. Cl. CPC H02J 9/00
USPC 307/23

(57) ABSTRACT

The invention relates to a system for managing the supply of energy for a number n of local energy networks where n≧2, each local energy network comprising at least one client device. Said system comprises a switching device connected to each network, an energy storage means, and a station for supplying the n networks with energy via switching devices, the station receiving the energy from a supply system, and the station is configured to determine and assign to each switching device:
A first mode wherein the energy storage means supplies energy to said network; or
A second mode wherein the station supplies energy simultaneously to said network and to said energy storage means.

### FIELD OF THE INVENTION

The invention relates to the centralized management of the supply of energy for a plurality of local energy networks. The invention relates more specifically to a method and a system for managing the supply of energy for a plurality of local energy networks intended to prevent a disruption in supply of energy for one of said networks. The invention also relates to a station for managing the supply of energy for a plurality of local energy networks for such a system.

### PRIOR ART

The issue of the management of the supply of energy for individual energy networks is increasingly critical as evidenced by recent developments in smart meters grids. In terms of individual energy networks, in recent years there has been a rapid development of energy supply systems based notably on the use of photo-voltaic panels covering the roofs of dwellings. These panels provide cheap and renewable electrical energy when they are illuminated by the sun that is to say at a time when the domestic network is consuming little energy. In general, these systems therefore comprise a means for storing the energy allowing deferred use of energy notably at times when the sun is down and when the energy needs of dwellings is higher. Moreover, it is likely that in a few years, the use of electric vehicles will be developed and that the batteries of these vehicles will provide substantial additional energy storage capacity when parked close to said dwellings.

Currently, the management of these energy storage means is very rudimentary: it aims mainly to enable storage of the excess energy produced during the day by photo-voltaic panels.

The operators which supply energy to individuals distribute the energy based on a distribution network whose architecture ends in general with a “star” structure: at the center of this structure is located a station managed by the operator which receives energy, at the ends of the branches of the structure are located the dwelling units to be supplied with energy. The role assigned to the station is to receive energy from an operator and to distribute it to the dwelling units. However, sometimes the level of energy which the station is able to convey to the dwelling units is not sufficient to meet the simultaneous demands of the dwelling units. This shortcoming is caused either by a too-low level of energy conveyed by the operator to the station or by a too-limited rate of energy on a part of the energy transport network between the station and the local networks. Some of the dwelling units can thus be affected by temporary disruptions in supply of energy.

The purpose of the invention is to prevent the disruption in supply for dwelling units by using energy reserves previously formed in the energy storage means mentioned above (which are available at the level of the dwelling units) and a centralized control at the level of the station of the supply of energy for the dwelling units: this control aims to rank the dwelling units according to the urgency for supplying them with energy.

When the energy supply limit of the station is caused by an energy production limit, the different embodiments of the invention make it possible to compensate for the production means shortcomings by temporally distributing the temporary peaks in energy demand. This is advantageous as the dimensioning of the energy production means is performed in general from the amplitude of the energy consumption peaks and it is considerably less expensive to reduce the amplitude of the infrequent consumption peaks by distributing the energy demand of the dwelling units (and therefore the supply of energy) over a longer period than to implement an additional energy production means enabling the demand of the consumption peak to be met.

When the energy supply limit of the station is caused by a too-limited rate of energy on a part of the energy transport network between the station and the local networks, the different embodiments of the invention make it possible to compensate for the shortcomings of the energy distribution network by preventing a replacement of the parts of the network, which saves time and money for the energy supply operator.

The invention is also advantageous in that it enables the local energy networks to prevent degradations of energy consumer devices connected to these networks which they encounter during a disruption in supply of energy and the problems of a practical nature induced by the operating faults of these devices.

### SUMMARY OF THE INVENTION

The idea behind the invention is to carry out a ranking at the level of the station of the dwelling units which the station is likely to supply with energy, or of the switching devices of the local energy transport networks which these dwelling units comprise, according to an order of urgency for externally supplying them with energy. This ranking is performed notably on the basis of the level of energy stored in the energy storage means of the dwellings or on the basis of an estimation of probability of absence of energy shortage at the level of the energy storage means connected to said networks over a future time period. These probabilities can for example be determined by making a Markov modulated demand process assumption by following for example methods implemented to evaluate the data traffic on communication networks. Examples of such methods are presented by Bali et al. in the article “An Algorithm for Fitting MMPP to IP Traffic Traces”, IEEE Communications Letters, Vol. 11, No. 2; February 2007 or by Asmussen in the work “Applied Probability and Queues”, Second edition, Springer-Verlag, New-York, 2003.

The station determines if the networks are supplied by energy supplied directly by the energy supply operator or by energy stored in their energy storage means, according to the rank which these networks occupy in this ranking.

To this end, an object of the invention is, according to a first aspect, a system for managing the supply of energy for a number n of local energy networks DENᵢ where n≧2 and 1≦i≦n, each local energy network DENᵢ comprising at least one client device DCL_{DENi} able to consume energy circulating on said network DENᵢ.

According to an embodiment of the invention, said system comprises a switching device COM_{DENi} connected to each network DENᵢ, an energy storage means PSD_{DENi} connected to said network DENᵢ via the switching device COM_{DENi}, and a station SUB for supplying the n networks DENᵢ with energy via switching devices COM_{DENi} associated with said networks, the station SUB receiving the energy from a supply system PSO, and the station SUB is configured to determine and assign to each switching device COM_{DENi}:
A first mode DRAIN wherein the energy storage means PSD_{DENi} supplies energy to said network DENᵢ; or
A second mode CHARGE wherein the station SUB supplies energy simultaneously to said network DENᵢ and to said energy storage means PSD_{DENi}.

Advantageously, the station SUB comprises means for ranking local networks DENᵢ on the basis of the levels of energy stored in the energy storage means PSD_{DENi} connected to said local networks DENᵢ or on the basis of a probability of absence of energy shortage at the level of said storage means PSD_{DENi}.

The station SUB considers a number K of successive time periods Tₖ where 1≦k≦K.

Advantageously, each switching device COM_{DENi} comprises means for delivering to the station SUB a first level CSL_{DENi,Tk} of energy stored in the energy storage means PSD_{DENi} at the end of each time period Tₖ and the station SUB determines at the end of the time period Tₖ an urgency index EI_{DENi} defining an order of priority for assigning the second mode CHARGE to the switching device COM_{DENi} for the period Tₖ₊ᵢ according to said first level CSL_{DENi,Tk}.

Advantageously, at the end of the time period Tk, the station SUB ranks the local networks DENᵢ according to increasing order of urgency indices EI_{DENi} in such a way that it constitutes an ordered list of local networks HDENⱼ where 1≦j≦n; the elements HDENⱼ of said ordered list have urgency indices EI_{HDENj} such that EI_{HDENj}≦EI_{HDENj+1} for 1≦j≦n−1 and EI_{HDENN}=Max(EI_{DENi}) where 1≦i≦n.

We use the assumption that the station SUB has a finite capacity for supplying energy: in other words, the station SUB cannot supply more than a level of energy C_{SUB} during the time period Tₖ.

Advantageously, at the end of the time period Tₖ, the station SUB determines a critical index value j* so that the level of energy C_{SUB} is comprised between a first level of cumulated energy which the station SUB would supply if it assigned the second mode CHARGE to the j* first elements of the ordered list HDEN, during the period Tₖ₊₁ and a second level of cumulated energy which the station SUB would supply if it assigned the second mode CHARGE to the j*+1 first elements of the ordered list HDENⱼ during the period Tₖ₊₁ and the station SUB assigns for the time period Tₖ₊₁ the second mode CHARGE to the switching devices COM_{HDENj} of the j* first elements HDENⱼ of the ordered list and the first mode DRAIN to the switching devices COM_{HDENj} of the n-j* last elements HDENⱼ of said ordered list.

Advantageously, each switching device COM_{DENi} delivers to the station SUB, at the end of the time period Tₖ, a second level CPL_{DENi,Tk} of energy consumed by the client device DCL_{DENi} during said time period Tₖ, the station SUB comprises means for storing said first levels CSL_{DENi,Tk} and said second levels CPL_{DENi,Tk}, the station SUB estimates, at the end of the time period Tₖ, an energy consumption <PRL_{DENi,Tk+1}> of the client device DCL_{DENi} for the time period Tₖ₊₁ from second levels CPL_{DENi,Tk} of energy stored for the previous time periods and the station SUB determines the critical index value j* from said energy consumptions <PRL_{DENi,Tk+1}>.

Advantageously, the station SUB comprises:
a means for assigning at the start of the time period Tₖ₊₁ the first mode DRAIN to all the switching devices of the networks DENᵢ and
a means for assigning the second mode CHARGE to the switching devices of the networks DENᵢ until the level of energy stored in the corresponding energy storage means is maximum, said assignments being performed in the order of the ordered list HDENⱼ.

Advantageously, the urgency index EI_{DENi} has a value representative of the first level CSE_{DENi,Tk} of energy or the urgency index EI_{DENi} is a probability of energy shortage of the energy storage means PSD_{DENi} during the period Tₖ₊₁ determined by making a Markov modulated demand process assumption. This assumption is used in general to estimate data traffic on communication networks.

Advantageously, the supply system is an operator.

An object of the invention is, according to a second aspect, a station SUB for managing the supply of energy for a number n of local energy networks DENᵢ where n≧2 and 1≦i≦n, each local energy network DENᵢ comprising at least one client device DCL_{DENi} able to consume energy circulating on said network DENᵢ, a switching device COM_{DENi} being connected to each network DENᵢ, an energy storage means PSD_{DENi} being connected to said network DENᵢ via the switching device COM_{DENi}, the station SUB receiving energy from a supply system PSO and able to supply the n networks DENᵢ with energy via devices COM_{DENi} associated with said networks.

The station SUB of the invention is configured to determine and assign to each switching device COM_{DENi}:
A first mode DRAIN wherein the energy storage means PSD_{DENi} supplies energy to said network DENᵢ; or
A second mode CHARGE wherein the station SUB supplies energy simultaneously to said network DENᵢ and to said energy storage means PSD_{DENi}.

Advantageously, the station comprises means for ranking local networks DENᵢ on the basis of levels of energy stored in the energy storage means PSD_{DENi} connected to said local networks DENᵢ or on the basis of a probability of absence of energy shortage at the level of said storage means PSD_{DENi}.

Preferably, the station SUB considers a number K of successive time periods Tₖ where 1≦k≦K.

According to an embodiment of the invention, it comprises:
a means M1 configured to receive at the end of the time period Tₖ a first level CSL_{DENi,Tk} of energy stored in the energy storage means PSD_{DENi} at the end of the time period Tₖ;
a means M2 configured to store said first levels CPL_{DENi,Tk}.
a means M3 configured to determine and assign to each switching device COM_{DENi}:
The first mode DRAIN; or
The second mode CHARGE.

An object of the invention is, according to a third aspect, a method for managing the supply of energy for a number n of local energy networks DEN, where n≧2 and 1≦i≦n, each local energy network DENᵢ comprising at least one client device DCL_{DENi} able to consume energy circulating on said network DENᵢ, a switching device COM_{DENi} being connected to each network DENᵢ, an energy storage means PSD_{DENi} being connected to said network DENᵢ via the switching device COM_{DENi}, and a station SUB able to supply the n networks DENᵢ with energy via switching devices COM_{DENi} associated with said networks, the station SUB receiving the energy from a supply system PSO.

The method of the invention comprises a step implemented by the station SUB for determining and assigning to each switching device COM_{DENi}:
A first mode DRAIN wherein the energy storage means PSD_{DENi} supplies energy to said network DENᵢ; or
A second mode CHARGE wherein the station SUB supplies energy simultaneously to said network DENᵢ and to said energy storage means PSD_{DENi}.

Advantageously, the method comprises a step for ranking local networks DENᵢ on the basis of levels of energy stored in the energy storage means PSD_{DENi} connected to said local networks DENᵢ or on the basis of a probability of absence of energy shortage at the level of said storage means PSD_{DENi}.

Preferably, the station SUB considers a number K of successive time periods Tₖ where 1≦k≦K and it is configured to determine and assign to each switching device COM_{DENi} during at least a fraction of the time period Tₖ₊₁:
The first mode DRAIN; or
The second mode CHARGE.

According to an embodiment of the invention, at the level of the station SUB, at the end of the time period Tₖ, the method comprises the steps consisting in:
S1 receiving from the switching devices of all local networks DENi and storing a first level CSL_{DENi,Tk} of energy stored in the energy storage means PSD_{DENi} at the end of each time period Tₖ;
S10 determining an urgency index EIDENᵢ defining an order of urgency for assigning the second mode CHARGE to the switching device COM_{DENi} for the period Tₖ₊₁, said urgency indices EI_{DENi} being determined from said first levels CSL_{DENi,Tk}, . . . , CSL_{DENi,Tk}, . . . , CSL_{DENn,Tk} associated with the network DENᵢ;
S20 ranking the local networks DEN, according to increasing order of urgency indices EI_{DENi} and thus constituting an ordered list of local networks HDENⱼ where 1≦j≦n, the local networks HDENⱼ in said ordered list having urgency indices EI_{HDENj,Tk} such that EI_{HDENj}≦EI_{HDENk+1} for 1≦j≦n−1 and EI_{HDENN}=Max(EI_{DENi})_{1≦i≦n};
S50;S51 assigning the second mode CHARGE to at least one switching device for the period Tₖ₊₁ chosen according to the rank j which the local network HDENⱼ occupies in said ordered list.
   Advantageously, said method further comprises the steps consisting in:
S1 receiving from all switching devices COM_{DENi} a second level CPL_{DENi,Tk} of energy consumed by the client device DCL_{DENi} during said period Tₖ and storing said second received levels CPL_{DENi,Tk};
S30 estimating an energy consumption <PRL_{i,Tk+1}> of the client device DCL_{DENi} for the time period Tₖ₊₁ from said first levels CPL_{i,Tk} of energy stored;
S40 determining, at the end of the time period Tₖ, from estimations of energy consumption <PRL_{i,Tk+1}> of the client device DCL_{DENi} for the time period Tₖ₊₁, a critical index value j* so that the level of energy C_{SUB} is comprised between a first level of cumulated energy which the station SUB would supply if it assigned the second mode CHARGE to the j* first local networks in the ordered list HDENⱼ during the period Tₖ₊₁ and a second level of cumulated energy which the station SUB would supply if it assigned the second mode CHARGE to the j*+1 first local networks in the ordered list HDENⱼ during the period Tₖ₊₁;
S50 assigning during the time period Tₖ₊₁ the second mode CHARGE to the switching devices of the j* first local networks in the ordered list HDENⱼ and the first mode DRAIN to the switching devices of the n-j* last local networks in the ordered list HDENⱼ.

An object of the invention is also a switching device COM_{DENi} connected to a local energy network DENᵢ comprising at least one client device DCL_{DENi} able to consume energy circulating on said network DENᵢ, said switching device comprising means for connecting an energy storage means PSD_{DENi} to said network DENᵢ, for supplying said network with energy from said energy storage means, and a station SUB for supplying the network DENᵢ with energy via said switching device COM_{DENi}, characterized in that said switching device COM_{DENi} is able to operate according to:
A first mode DRAIN wherein the energy storage means PSD_{DENi} supplies energy to said network DENᵢ; or
A second mode CHARGE wherein the station SUB supplies energy simultaneously to said network DENᵢ and to said energy storage means PSD_{DENi}.

### BRIEF DESCRIPTION OF THE DRAWINGS

The invention will be better understood upon reading the following detailed description of an example embodiment of the invention. This description is provided for information only and refers to the annexed drawings wherein:

FIG. 1 shows a local energy network connected to a station according to an embodiment of the invention;

FIG. 2a (respectively 2b) shows the path followed by the energy supplying the network DEN₁ when the switching device COM₁ is placed in a first mode called “DRAIN” (respectively in a second mode called “CHARGE”);

FIG. 3 shows a system for managing the supply of energy for a plurality of local energy networks according to an embodiment of the invention, said system simultaneously supplying 4 local energy networks:

FIG. 4 shows a flowchart of a method for managing the supply of energy for a plurality of local energy networks according to a first embodiment of the invention;

FIG. 5 shows an example embodiment of step S40 of said method;

FIG. 6 shows a flowchart of a method for managing the supply of energy for a plurality of local energy networks according to a second embodiment of the invention;

FIG. 7 shows a simplified view of the architecture of the station SUB according to the invention.

### DETAILED DESCRIPTION OF PREFERRED EMBODIMENTS

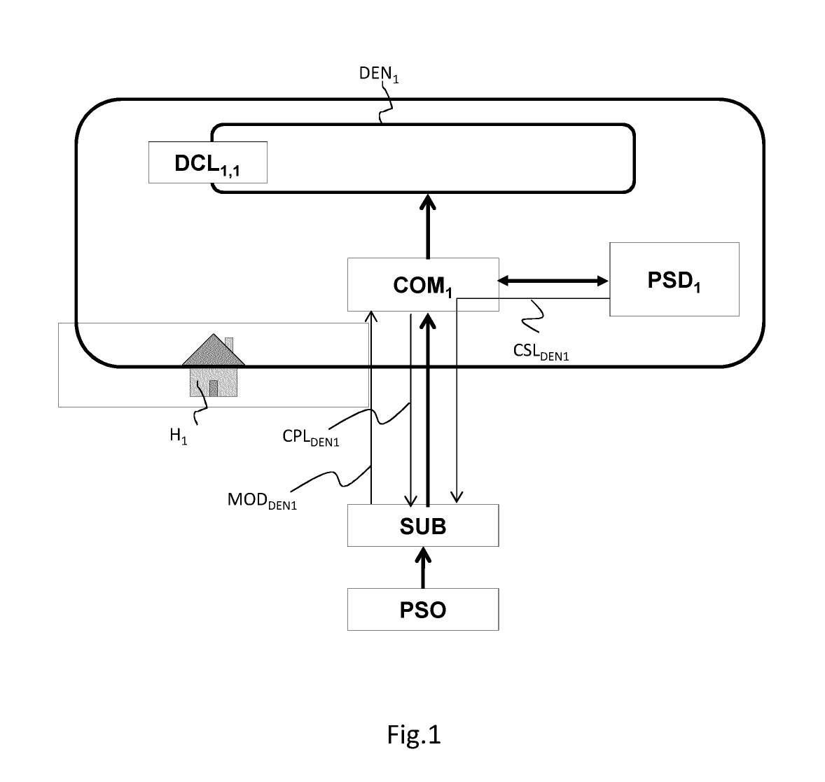

FIG. 1 shows a local energy transport network DEN, comprising at least one client device DCL_{1,1} configured to consume the energy carried on said network DEN₁.

By “local energy transport network” is understood an energy transport network wherein access to energy is centralized on a particular node where a switching device COM_{DEN1} may be placed. This switching device COM_{DEN1} is configured to control the supply of energy for the whole of the local network DEN₁.

In the description which follows, the network DEN₁ is a local electricity transport network. But it goes without saying that the embodiment of the invention is not restricted to managing the supply of electricity for local electricity transport networks.

The network DEN₁ equips for example an individual dwelling unit: this is then referred to as a domestic network. However, the local energy transport networks DEN₁ are not restricted to domestic networks only and can also equip industrial production units: for example a building comprising an item of equipment for industrial use functioning using energy supplied by an energy source external to the network DEN₁.

An energy storage means PSD_{DEN1} is connected to the network DEN₁ via the device COM_{DEN1}. Thus, the client device DCL_{1,1} which is connected to the electrical network DEN₁ can be supplied with electrical energy either by electricity directly supplied by an energy supply operator PSO, here electricity from an electrical energy source external to the network DEN₁, or by the electricity stored in the energy storage means PSD_{DEN1}. The origin of the electricity consumed by the device DCL₁ is defined by the configuration mode of the device COM_{DEN1}.

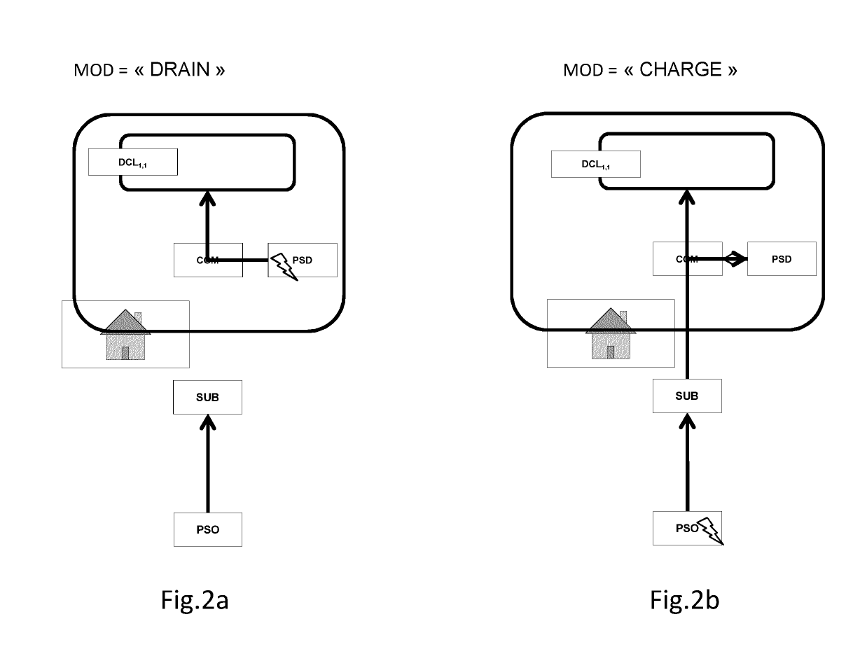

Placed in a particular configuration mode called “CHARGE”, the switching device COM_{DEN1} authorizes the operator PSO to supply energy to the client devices connected to the network DEN₁ by an energy source external to the local network DEN₁. Placed in another configuration mode “DRAIN”, the switching device COM_{DEN1} can block the supply of energy for the network DEN₁ by the operator PSO and transform the energy storage means into an energy source for the client devices connected to the network DEN₁. These configuration modes will be described in more detail using FIGS. 2a and 2b.

The storage means PSD_{DEN1} is preferentially a fixed means connected to the dwelling unit, thus the storage means PSD_{DEN1} has a storage capacity MSL_{DEN1} which is finite, determined and constant in time. In other words, the storage means PSD_{DEN1} can store energy as long as the level of energy which it contains does not exceed MSL_{DEN1}. The storage means PSD_{DEN1} constitutes an energy source for supplying the network DEN₁ while the level of energy which it contains is greater than 0.

But, the storage means PSD_{DEN1} could also comprise mobile parts such as for example an electric battery of a motor vehicle offering an energy storage capacity only when the vehicle is parked close to the dwelling and when the battery of the vehicle is connected to the local network via the device COM_{DEN1}. The description of the invention would only be changed in that the storage capacity MSL_{DEN1} would fluctuate in time.

In the remainder of the description, it will be assumed that the operator PSO is the only electricity supplier for the network and that it supplies electricity from a single external source to the network DEN₁. The operator PSO transports the energy produced by said source to the local network. The energy stored in the storage means PSD_{DEN1} has the same origin: it is supplied by the operator PSO.

The energy source is for example a nuclear energy power plant. It goes without saying that the energy supplied by the operator PSO can be produced by several sources simultaneously.

The energy source and the storage means PSD_{DEN1} are both connected to the network DEN₁ via the switching device COM_{DEN1} which can be configured according to:
A first mode, shown diagrammatically in FIG. 2a, wherein the energy storage means PSD_{DEN1} alone supplies the client device DCL_{1,1} with the energy which it contains via the switching device COM_{DEN1}; or
A second mode, shown diagrammatically in FIG. 2b, wherein the operator PSO supplies energy to the client device DCL_{1,1} and simultaneously charges with energy (that is to say supplies with energy) the storage means PSD_{DEN1} via the switching device COM_{DEN1}.

In FIG. 1, the thin arrows represent the flows of information. In FIGS. 2a and 2b, the bold arrows represent a flow of energy.

In FIGS. 2a and 2b, a lightning bolt represents the energy source supplying the client device DCL_{1,1}.

In what follows, it will be considered that the station SUB divides the time into successive time periods Tₖ where 1≦k≦K, preferably of identical durations. The set of periods Tₖ forms a time cycle C₁. The time cycles are successive, periodic and preferably identical where 1 is an index identifying each time cycle C₁. To illustrate the invention in a simple manner, time cycles C₁ with durations corresponding to 24 hours are considered. The time cycle C₁ is divided into a number K=24 of successive time periods T₁, . . . , T₂₄.

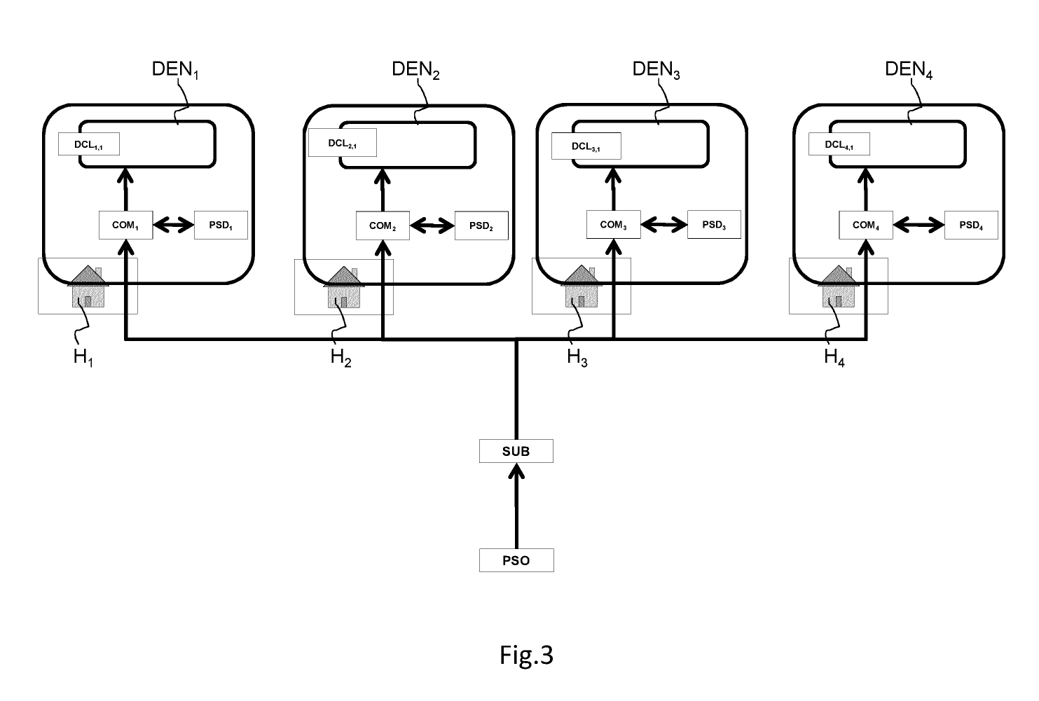

We take a situation such as that shown in FIG. 3 where a station SUB is configured to supply with energy a plurality of local energy networks DEN, where 1≦i≦4 identical to the network DEN₁ of FIG. 1, and where the station SUB is not able to supply simultaneously to these four networks DEN₁ a cumulated level of energy as high as that which the local networks consume.

As explained above, the energy storage means PSD_{DEN1} of each local network DEN₁ constitutes an energy reserve of the network DEN₁. This energy reserve can be used, as long as it is not exhausted, in place of a direct supply of energy by the operator PSO. The station SUB can therefore rank the networks DEN₁ to be directly supplied with energy according to an order of priority or in other words an order of urgency for supplying them with energy in order to prevent an energy shortage.

In what follows, two embodiments of a system and a method for managing the supply of energy for a local energy network are successively presented.

A first embodiment is advantageous in that it implements a simple switching device mode control: a mode is assigned to a switching device at the start of a time period Tₖ₊₁ for the whole of the duration of the time period Tₖ₊₁.

A second embodiment is advantageous in that it only requires a reduced number of calculations as the local networks are ranked according to the level CSL_{DEN1} of energy stored in the energy storage means PSD_{DEN1} at the end of time period Tₖ. Hereafter, this level of energy will be denoted CSL_{DENi,Tk}.

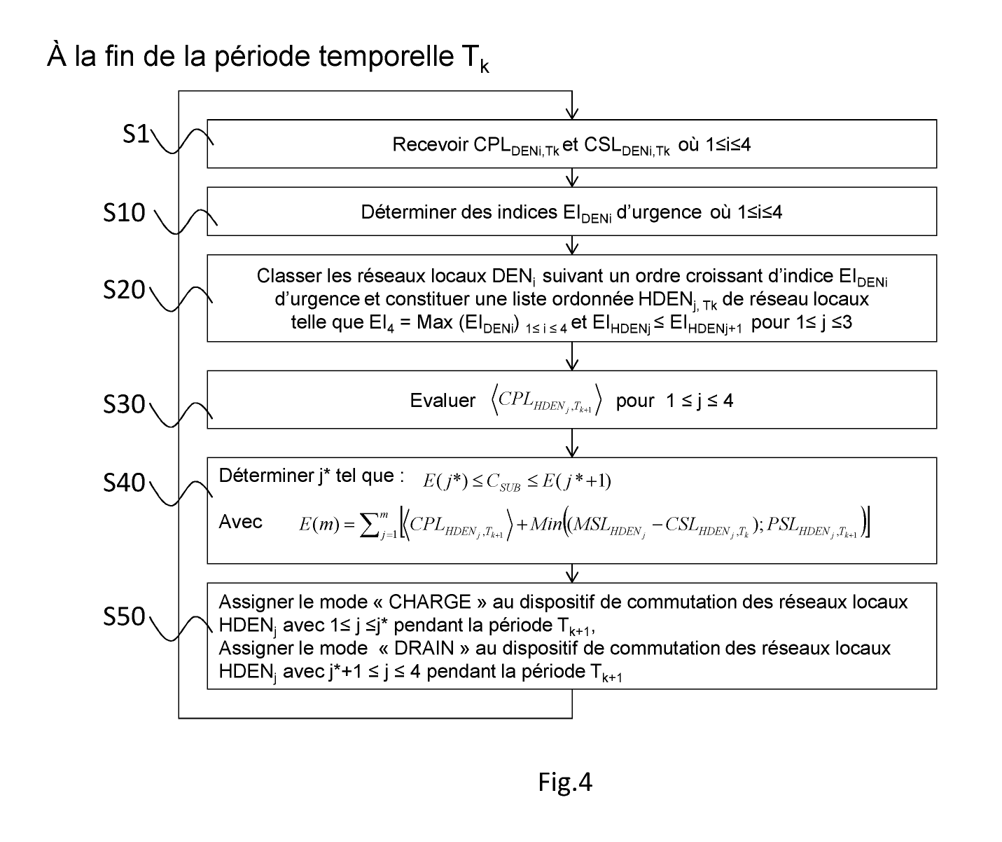

In a first part, the first embodiment of the invention is described based on the flowchart of FIG. 4 implemented for the system shown in FIG. 3.

At the end of a time period Tₖ, in a step S1, the station SUB receives a first level CSL_{DENi,Tk} of energy stored in the storage means PSD_{DENi} and a second level CPL_{DENi,Tk} of energy consumed by the client device DCL_{DENi} during said time period Tₖ for 1≦i≦4. In this first embodiment, the station SUB determines from among the first and second modes a configuration mode MOD_{DENi,Tk} in which each switching device COM_{DENi} operates.

The first level CSL_{DENi, Tk} of energy is preferably delivered by each storage means PSD_{DENi} to the switching device COM_{DENi} of the local network DENi to which it is connected. The first levels CSL_{DENi,Tk} are immediately relayed to the station SUB. In the situation shown in FIG. 3, a single energy storage means PSD_{DENi} is connected to the local network DENᵢ. If several energy storage means were connected to the network DENᵢ, each of them would deliver a first level of energy and it is then a first level of energy cumulating the different levels of energy stored in these energy storage means which would be transmitted to the station SUB in contact with the local network DENᵢ.

The second level CPL_{DENi,Tk} of energy is preferably delivered directly by each switching device COM_{DENi} to the station SUB. In the situation shown in FIG. 3, a single client device DCL_{i,1} is connected to the local network DENi and is likely to consume energy. If a plurality of client devices was connected to the network DEN the device COM_{DENi} would deliver to the station SUB a second level of energy cumulating the different levels of energy consumed by this plurality of client devices.

In a step S10, the station SUB determines urgency indices EI_{DENi} indicating the priority for supplying the networks DENᵢ with energy by an external source during the period Tₖ₊₁, that is to say indicating the priority in which a switching device COM_{DENi} must be placed in “CHARGE” mode during the period Tₖ₊₁. At the end of each time period Tₖ, a value is therefore assigned to the urgency indices EI_{DENi} for each i comprised between 1 and 4.

Preferentially, such an urgency index can be expressed in the form of the first level CSL_{DENi,Tk} of energy. In this case, the lower the level of energy stored in the energy storage mean(s) of a local network DENᵢ, the more urgency to place the switching device COM_{DENi} of the local network DENᵢ in “CHARGE” mode.

Alternatively, the urgency index (EI_{DENi}) is a probability of absence of energy shortage in the energy storage means (PSD_{DENi}) during the time period Tₖ₊₁ which is determined by making a Markov modulated demand process assumption. In this case, the lower the probability of absence of energy shortage in the energy storage mean(s) of a local network DENᵢ, the more urgency to place the switching device COM_{DENi} of the local network DENᵢ in “CHARGE” mode.

In a step S20, the station ranks the local networks DENᵢ according to an increasing order of urgency indices. Expressed otherwise, the station SUB constitutes an ordered list HDENⱼ of local networks such that EI₄=Max (EI_{DENi})_{1≦i≦4} and EI_{HDENj}≦EI_{HDENj+1} for 1≦j ≦3. The ordered list HDENⱼ comprises all the local networks DENᵢ arranged according to increase order of urgency.

When it is not possible to supply all the local networks DENᵢ with energy simultaneously due to a limit level of energy which it is capable of supplying during the time period Tₖ, the station SUB must determine an index j* enabling the ordered list to be separated into two sub-lists. A first sub-list groups together the local networks whose rank j in the ordered list HDENⱼ is comprised between 1 and j*, that is to say with 1≦j≦j*. A second sub-list groups together the local networks whose rank j in the ordered list HDENⱼ is comprised between j*+1 and 4 that is to say with j*+1≦j≦4.

The station SUB assigns during the period Tₖ₊₁ the “CHARGE” mode to the switching devices connected to the local networks forming part of the first sub-list extracted from the ordered list established at the end of the period Tₖ.

The station SUB assigns during the period Tₖ₊₁ the “DRAIN” mode to the switching devices connected to the local networks forming part of the second sub-list extracted from the ordered list established at the end of the period Tₖ.

This dual action is performed during a step S50.

Knowing the energy level capacity C_{SUB} to be supplied, j* is sought such that the level of energy C_{SUB} is comprised between a first level of cumulated energy which the station SUB would supply if it supplied j* first elements of the ordered list HDENⱼ with energy during the period Tₖ₊₁ and a second level of cumulated energy which the station SUB would supply if it supplied j*+1 first elements of the ordered list HDENⱼ with energy during the period Tₖ₊₁.

Steps S30 and S40 shown in FIG. 4 constitute an example of determination of the critical index j *.

Step S30 consists in evaluating the (future) consumption [symbol] CPL_{HDEN}_{ⱼ}_{,T}_{ₖ₊₁} [symbol] of the client device or devices connected to the local networks HDENⱼ for 1≦j ≦4 for the purpose of the estimation of a cumulated level E(m) of energy corresponding to an estimation of the level of energy consumed by the m first local networks in the ordered list HDENⱼ. E(m) is naturally a function of Σⱼ₌₁^{j=m} [symbol] CPL_{HDEN}_{ⱼ}_{,T}_{ₖ₊₁} [symbol] . E(m) also comprises the sum of the levels of energy used to charge the energy storage means associated with the network HDENⱼ when the switching device of the network HDENj is in “CHARGE” mode. This level of energy cannot exceed MSL_{HDEN}_{ⱼ}−CSL_{HDEN}_{ⱼ}_{,T}_{ₖ} where MSL_{HDENj} is the maximum level of energy which the energy storage means connected to the local network HDENⱼ can contain. When there is also a limit in terms of rate of level of energy on the path linking the station SUB and the storage means or a limit related to the energy storage speed by the storage means, we denote PSL_{HDENj;Tk} the maximum level of energy transferable to the storage means connected to the local network HDENⱼ during the time period Tₖ₊₁, and in this situation the maximum level of energy which can be used to charge the storage means is Min ((MSL_{HDEN}_{ⱼ}−CSL_{HDEN}_{ⱼ}_{,T}_{ₖ}); PSL_{HDEN}_{ⱼ}_{,T}_{ₖ₊₁}).

And thus, E(m) can be expressed in the form:

E(m)=Σⱼ₌₁^{m}└ [symbol] CPL_{HDEN}_{ⱼ},Tₖ₊₁ [symbol] +Min((MSL_{HDEN}_{ⱼ}−CSL_{HDEN}_{ⱼ}_{,T}_{ₖ}); PSL_{HDEN}_{ⱼ}_{,T}_{ₖ₊₁})┘

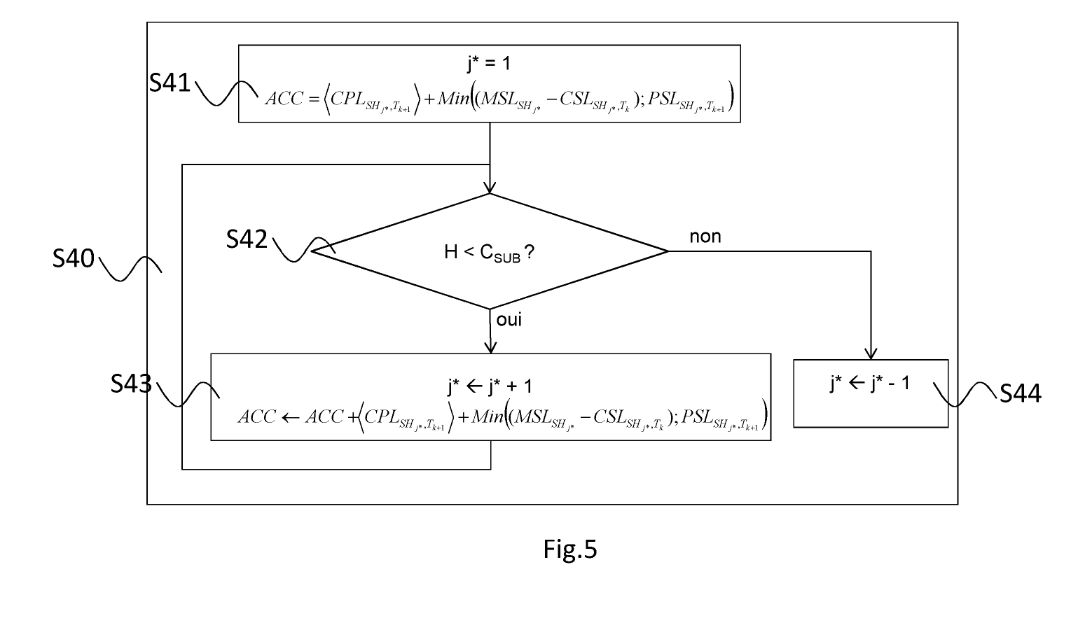

Step S40 presented in the flowchart in FIG. 5 corresponds to an example of a method for determination of the critical index j*. This method consists in seeking the first integer j*, here comprised between 1 and 4 such that E(j*)≦C_{SUB}≦E(j*+1). In step S41, the level of cumulated energy required for the station SUB is initialized for j=1.

In step S42, a test is carried out to check that the current index j is such that the station can supply the j elements with the highest urgency index in CHARGE mode.

If the test is positive, then, in step S43, the current index j is increased by 1 and the level of cumulated energy required to put the j elements with the highest urgency index into CHARGE mode is updated. The test is then reiterated in step S42.

If the test is negative, the critical index j* is chosen in step S44 as being equal to j−1.

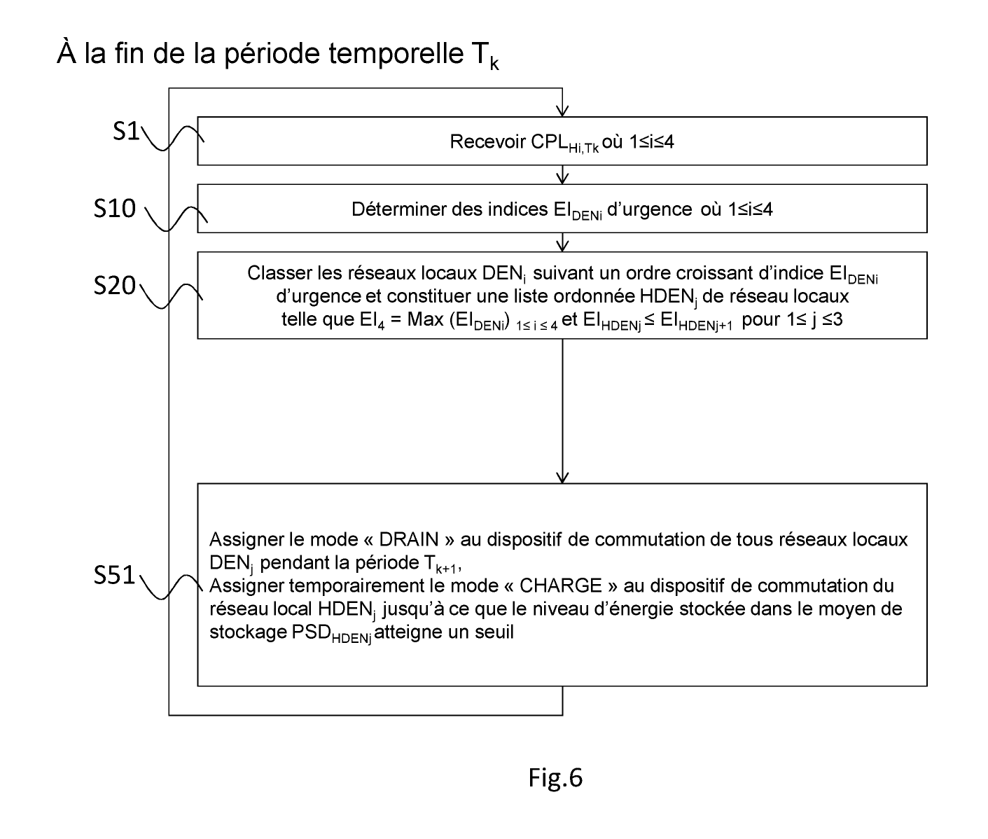

In a second part, the second embodiment of the invention is described based on the flowchart of FIG. 6 implemented for the system shown in FIG. 3.

Step S1 of the second embodiment differs from step S1 of the first embodiment in that only the first level CSL_{DENi,Tk} of energy stored in the storage means PSD_{DENi} at the end of the period Tk is received by the station SUB.

Steps S10 and S20 of the second embodiment are identical to steps S10 and S20 of the first embodiment.

Step S51 of the second embodiment is distinguished from step S50 of the first embodiment in that:

The “DRAIN” mode is assigned to the switching devices COM_{DENi} of all the local networks DENᵢ except to a switching device COM_{DENi} of one of the local networks to which is temporarily assigned the “CHARGE” mode. This temporary assignment of the “CHARGE” mode ends when the level of energy stored in the energy means associated with this local network reaches a predefined level of energy PLL_{DENi}, for example when the level of energy reaches the maximum level, MSL_{DENi}, that is to say when the maximum capacity of the storage means is reached.

Once the level of energy has reached the threshold, the station SUB assigns the “DRAIN” mode to the switching device, and the station SUB temporarily assigns the “CHARGE” mode to a new switching device. The order in which the switching devices are successively placed in the “CHARGE” mode is that in which the local networks HDENⱼ feature in the ordered list.

In other words, initially, the switching device of the local network HDEN₁ is the only switching device placed in the CHARGE mode, then if the level of energy stored in the energy storage means connected to the network HDENⱼ reaches the threshold before the end of the period T_{k+i,} it is placed in the “DRAIN” mode and the operation is repeated iteratively with the switching device of the local network HDEN₂ and the other local networks HDENⱼ until the end of the time period T_{k+1.}

Advantageously, each energy storage means comprises either means for delivering to the station SUB, for example transiting the switching device of the local network, an item of information indicating that the level of energy stored in said energy storage means has reached the threshold, or means for delivering to the station SUB, for example transiting the switching device of the local network, in real time an item of information indicating the level of energy stored in the energy storage means. In this case, the station SUB must comprise means for analyzing said information in order to change the assignment of the “CHARGE” mode to “DRAIN” mode when this level of energy has reached said threshold.

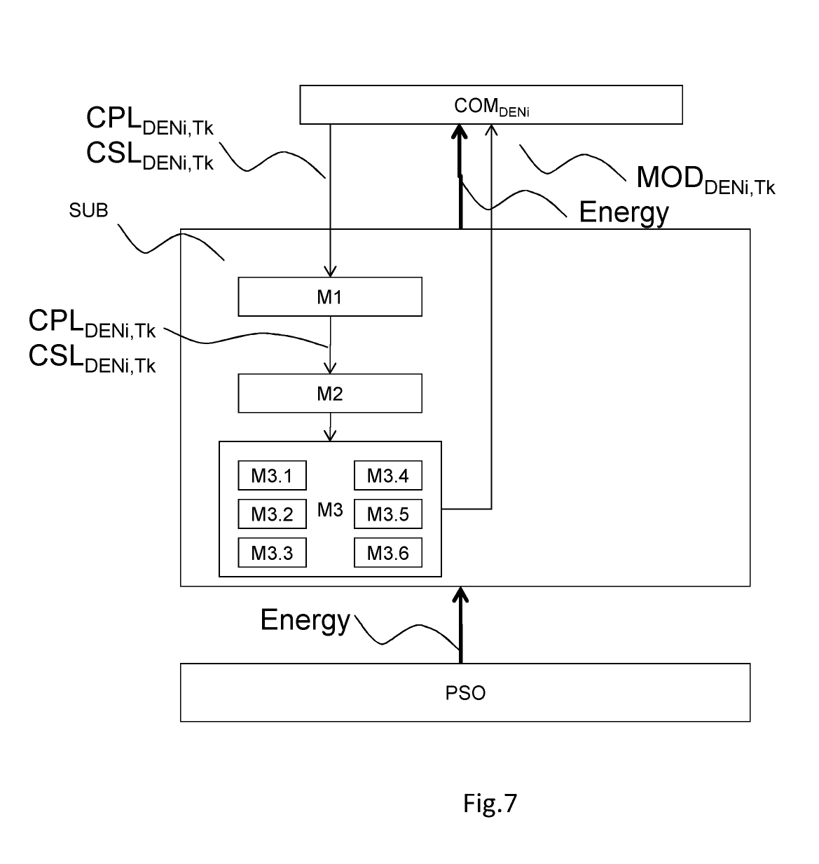

FIG. 7 shows the architecture of a station SUB for managing the supply of energy for a number n of local energy networks DEN, where n≧2 and 1≦i≦n according to an embodiment of the invention as shown in FIG. 3.

According to the embodiments of the invention the station SUB comprises:
a means M1 configured to receive at the end of the time period Tₖ a first level CSL_{DENi,Tk} of energy stored in the energy storage means PSD_{DENi} at the end of the time period Tₖ;
a means M2 configured to store said first levels CSL_{DENi,Tk}.
a means M3 configured to determine and assign to each switching device COM_{DENi}:
   A first mode DRAIN wherein the energy storage means PSD_{DENi} supplies energy to said network DENᵢ; or
   A second mode CHARGE wherein the station SUB supplies energy simultaneously to said network DENᵢ and to said energy storage means PSD_{DENi}.

Advantageously, the means M1 is further configured to receive at the end of the time period Tₖ a second level CPL_{DENi,Tk} of energy consumed by the client device DCL_{DENi} during said time period Tₖ and the means M2 is further configured to store said second levels CPL_{DENi,Tk}.

Advantageously, the means M3 comprises:

a means M3.1 configured to determine, at the end of the time period Tₖ, an urgency index EI_{DENi} defining an order of priority for assigning the second mode CHARGE to the switching device COM_{DENi} for the period Tₖ₊₁, said urgency indices EI_{DENi} are determined from said first levels CSL_{DEN1,Tk}, . . . , CSL_{DENi,Tk}, . . . , CSL_{DENn,Tk} associated with the network DENi stored in the station SUB;

a means M3.2 configured to rank, at the end of the time period Tk, the local networks DENi according to increasing order of urgency indices EIDENi and to thus constitute an ordered list of local networks HDENⱼ where 1≦j≦n; the elements HDENⱼ of said ordered list have urgency indices EI_{HDENj} such that EI_{HDENj}≦EI_{HDENj+1} for 1≦j≦n−1 and EI_{HDENN}=MaxEI_{DENi} for 1≦i≦n;

a means M3.3 configured to estimate, at the end of the time period Tk, an energy consumption <PRL_{DENi,Tk+1}> of the client device DCL_{DENj} for the time period Tₖ₊₁ from first levels CPL_{i,Tk} of energy stored for the previous time periods.

Advantageously, the means M3 also comprises:
a means M3.4 configured to determine, at the end of the time period Tₖ, from estimations of energy consumption <PRL_{DENi,Tk+1}> of the client device DCL_{DENi} for the time period Tₖ₊₁, a critical index value j* so that the level of energy C_{SUB} is comprised between a first level of cumulated energy which the station SUB would supply if it assigned the second mode CHARGE to the j* first local networks in the ordered list HDENⱼ during the period Tₖ₊₁ and a second level of cumulated energy which the station SUB would supply if it assigned the second mode CHARGE to the j*+1 first local networks in the ordered list HDENⱼ during the period Tₖ₊₁;
a means M3.5 configured to assign during the time period Tₖ₊₁ the second mode

CHARGE to the switching devices of the j* first local networks in the ordered list HDENⱼ and the first mode DRAIN to the switching devices of the n-j* last local networks in the ordered list HDENⱼ.

Advantageously, the means M3 further comprises a means M3.6 configured to assign during the time period Tₖ₊₁ the first mode DRAIN to all the switching devices of the local networks in the ordered list HDENⱼ, and said means M3.6 is further configured to assign temporarily the second mode CHARGE to the switching devices of the first local networks taken in the order of the ordered list HDENⱼ until the level of energy stored in the energy storage means of the local network reaches an energy level threshold PLL_{DENi}.

Although the invention has been described in relation to two particular embodiments, it is obvious that it is in no way restricted and that it comprises all the technical equivalents of the means described together with their combinations if the latter fall within the scope of the invention.

1-22. (canceled)

23. System for managing the supply of energy for a number n of local energy networks where n≧2, each local energy network comprising at least one client device able to consume energy circulating on said network, said system comprising a switching device connected to each network, an energy storage means connected to said network via the switching device, and a station for supplying the n networks with energy via the switching devices associated with said networks, the station receiving the energy from a supply system, the station being configured to determine and assign to each switching device:
A first mode wherein the energy storage means supplies energy to said network; or
A second mode wherein the station supplies energy simultaneously to said network and to said energy storage means,
wherein the station considering a number K of successive time periods Tₖ where 1≦k≦K, each switching device comprises means for delivering to the station a first level of energy stored in the energy storage means at the end of each time period Tₖ and the station determines at the end of the time period Tₖ an urgency index defining an order of priority for assigning the second mode to the switching device for the period Tₖ₊₁ according to said first level.

24. System according to claim 23, wherein the station comprises means for ranking local networks on the basis of levels of energy stored in the energy storage means connected to said local networks or on the basis of a probability of absence of energy shortage at the level of said storage means.

25. System according to claim 23, wherein at the end of the time period Tk, the station ranks the local networks according to increasing order of urgency indices in such a way that is constitutes an ordered list of local networks HDENj where 1≦j≦n; the elements HDENⱼ of said ordered list having urgency indices EI_{HDENj} such that EI_{HDENj}≦EI_{HDENj+1} for 1 ≦j≦n−1 and EI_{HDENN}=Max(EI_{DENi}) where 1≦i≦n.

26. System according to claim 25, the station being limited to supplying a level of energy during the time period Tₖ, wherein at the end of the time period Tₖ, the station determines a critical index value j* so that the level of energy is comprised between a first level of cumulated energy which the station would supply if it assigned the second mode to the j* first elements of the ordered list during the period Tₖ₊₁ and a second level of cumulated energy which the station would supply if it assigned the second mode to the j*+1 first elements of the ordered list during the period Tₖ₊₁ and the station assigns for the time period Tₖ₊₁ the second mode to the switching devices of the j* first elements of the ordered list and the first mode to the switching devices of the n-j* last elements of said ordered list.

27. System according to claim 26, wherein each switching device delivers to the station, at the end of the time period Tₖ, a second level of energy consumed by the client device during said time period Tₖ, the station comprises means for storing said first levels and said second levels, the station estimates, at the end of the time period Tₖ, an energy consumption of the client device for the time period Tₖ₊₁ from second levels of energy stored for the previous time periods and the station determines the critical index value j* from said energy consumptions.

28. System according to claim 25, the station being limited to supplying a level of energy during the time period Tₖ, wherein the station comprises:
a means for assigning at the start of the time period Tₖ₊₁ the first mode to all the switching devices of the networks and
a means for assigning the second mode to the switching devices of the networks until the level of energy stored in the corresponding energy storage means is maximum, said assignments being performed in the order of the ordered list.

29. System according to claim 25, wherein the urgency index has a value representative of the first level of energy or the urgency index is a probability of energy shortage of the energy storage means during the period Tₖ₊₁ determined by making a Markov modulated demand process assumption.

30. System according to claim 23, wherein the supply system is an operator.

31. Station for managing the supply of energy for a number n of local energy networks where n≧2, each local energy network comprising at least one client device able to consume energy circulating on said network, a switching device being connected to each network, an energy storage means being connected to said network via the switching device, the station receiving energy from a supply system and able to supply the n networks with energy via switching devices associated with said networks, said station being configured to determine and assign to each switching device
A first mode wherein the energy storage means supplies energy to said network; or
A second mode wherein the station supplies energy simultaneously to said network and to said energy storage means,
wherein said station considering a number K of successive time periods Tₖ where 1≦k≦K, it comprises:
a means M1 configured to receive at the end of the time period Tₖ a first level (of energy stored in the energy storage means at the end of the time period Tₖ;
a means M2 configured to store said first levels;
a means M3 configured to determine and assign to each switching device:
the first mode; or
the second mode.

32. Station according to claim 31, comprising means for ranking local networks on the basis of levels of energy stored in the energy storage means connected to said local networks or on the basis of a probability of absence of energy shortage at the level of said storage means.

33. Station according to claim 31, wherein the means M1 is further configured to receive at the end of the time period Tₖ a second level of energy consumed by the client device during said time period Tₖ and the means M2 is further configured to store said second levels.

34. Station according to claim 31, the station being limited to supplying a level of energy during the time period Tₖ, wherein the means M3 comprises:
a means M3.1 configured to determine, at the end of the time period Tₖ, an urgency index defining an order of priority for assigning the second mode to the switching device for the period Tₖ₊₁, said urgency indices being determined from said first levels associated with the network stored in the station;
a means M3.2 configured to rank, at the end of the time period Tₖ, the local networks according to increasing order of urgency indices and thus to constitute an ordered list of local networks HDENⱼ where 1≦j≦n; the elements HDENⱼ of said ordered list have urgency indices EI_{HDENj} such that EI_{HDENj}≦EI_{HDENj+1} for 1≦j≦n−1 and EI_{HDENN}=Max(EI_{DENi})_{1≦i≦n};
a means M3.3 configured to estimate, at the end of the time period Tₖ, an energy consumption of the client device for the time period Tₖ₊₁ from first levels of energy stored for the time periods previous to the time period Tₖ₊₁.

35. Station according to claim 34, wherein the means M3 further comprises:
a means M3.4 configured to determine, at the end of the time period Tₖ, from estimations of energy consumption of the client device for the time period Tₖ₊₁, a critical index value j* so that the level of energy is comprised between a first level of cumulated energy which the station would supply if it assigned the second mode to the j* first local networks in the ordered list during the period Tₖ₊₁ and a second level of cumulated energy which the station would supply if it assigned the second mode to the j*+1 first local networks in the ordered list during the period Tₖ₊₁;
a means M3.5 configured to assign during the time period Tₖ₊₁ the second mode to the switching devices of the j* first local networks in the ordered list and the first mode to the switching devices of the n-j* last local networks featuring in the ordered list.

36. Station according to claim 35, wherein the means M3 further comprises a means M3.6 configured to assign during the time period Tₖ₊₁ the first mode to all the switching devices of the local networks in the ordered list and said means M3.6 is further configured to assign temporarily the second mode to the switching devices of the first local networks taken in the order of the ordered list until the level of energy stored in the energy storage means of the local network reaches an energy level threshold.

37. Method for managing the supply of energy for a number n of local energy networks where n≧2, each local energy network comprising at least one client device able to consume energy circulating on said network, a switching device being connected to each network, an energy storage means being connected to said network via the switching device, and a station able to supply the n networks with energy via switching devices associated with said networks, the station receiving the energy from a supply system, said method comprising a step implemented by the station for determining and assigning to each switching device:
A first mode wherein the energy storage means supplies energy to said network; or
A second mode wherein the station supplies energy simultaneously to said network and to said energy storage means,
the station considering a number K of successive time periods Tk where 1≦k≦K and being configured to determine and assign to each switching device during at least a fraction of the time period Tₖ₊₁:
the first mode; or
the second mode;
wherein, at the level of the station, at the end of the time period Tₖ, said method comprises the steps consisting in:
receiving from the switching devices of all local networks and storing a first level of energy stored in the energy storage means at the end of each time period Tₖ;
determining an urgency index defining an order of urgency for assigning the second mode to the switching device for the period Tₖ₊₁, said urgency indices being determined from said first levels associated with the network;
ranking the local networks according to increasing order of urgency indices and thus constituting an ordered list of local networks HDENⱼ where 1≦j≦n, the local networks HDENⱼ in said ordered list having urgency indices EI_{HDEN}ⱼ such that EI_{HDENj}≦EI_{HDENj+1} for 1≦j≦n−1 and EI_{HDENN}=Max(EI_{DENi})_{1≦i≦n};
assigning the second mode to at least one switching device for the period Tₖ₊₁ chosen according to the rank j which the local network HDENⱼ occupies in said ordered list.

38. Method according to claim 37, comprising a step for ranking local networks on the basis of levels of energy stored in the energy storage means connected to said local networks or on the basis of a probability of absence of energy shortage at the level of said storage means.

39. Method according to claim 37, further comprising the steps consisting in:
receiving from all switching devices a second level of energy consumed by the client device during said period Tₖ and storing said second received levels;
estimating an energy consumption of the client device for the time period Tₖ₊₁ from said first levels of energy stored;
determining, at the end of the time period Tₖ, from estimations of energy consumption of the client device for the time period Tₖ₊₁, a critical index value j* so that the level of energy is comprised between a first level of cumulated energy which the station would supply if it assigned the second mode to the j* first local networks in the ordered list during the period Tₖ₊₁ and a second level of cumulated energy which the station would supply if it assigned the second mode to the j*+1 first local networks in the ordered list during the period Tₖ₊₁;
assigning during the time period Tₖ₊₁ the second mode to the switching devices of the j* first local networks in the ordered list and the first mode to the switching devices of the n-j* last local networks in the ordered list.

40. Method according to claim 37, wherein the urgency index has a value representative of the first level of energy or the urgency index is a probability of absence of energy shortage of the energy storage means during the period Tₖ₋₁ which is determined by making a Markov modulated demand process assumption.
